(19) United States
(12) Patent Application Publication
(10) Pub. No.: US 2006/0195987 A1
(43) Pub. Date: Sep. 7, 2006

(54) Motorized cot for use with emergency vehicles

(76) Inventor: Nathan R. Walkingshaw, Sandy, UT (US)

Correspondence Address: KIRTON AND MCCONKIE;1800 EAGLE GATE TOWER, 60 EAST SOUTH TEMPLE, P O BOX 45120, SALT LAKE CITY, UT, 84145-0120, US

(21) Appl. No.: 11/074,149

(22) Filed: Mar. 7, 2005

(51) Int. Cl. A61G 1/013; B62D 55/00; B62B 13/00; B62B 5/02

(52) U.S. Cl. 5/627; 180/9.22; 180/65.1; 280/5.22; 280/5.24; 280/23.1; 5/625

(57) ABSTRACT

The present invention relates to an emergency vehicle cot that includes an incline support system and a movement system. The incline support system is a retractable system disposed on the bottom of the cot to support one end the cot on an inclined and/or irregular surface during transportation. For example, one embodiment of an incline support system includes two members that are configured to extend from the inclined end of the cot at a particular angle. The extended members support the cot a particular distance over the inclined surface thereby minimizing the need for an emergency worker to manually support the inclined end of the cot. The movement system is coupled to the incline support system and utilizes rotational movement to allow the supported inclined end of the cot to move over the inclined surface. For example, one embodiment of a movement system includes a rotatable track with a motor system and a brake system. The incline support system and the movement system are configured to be retractable or concealable within the cot to facilitate using the cot as a traditional emergency vehicle cot.

### BACKGROUND

1. Field of the Invention

The present invention relates to a cot, and in particular to an emergency vehicle cot including an incline support system and movement system.

2. Background

Cots are used to transport incapacitated or injured individuals from one location to another. For example, EMTs typically transport emergency medical patients from one location into their ambulances using cots. Early cots merely consisted of cloth stretched between two poles. A patient was positioned on the cloth and two emergency workers carry either end of the poles thereby supporting the patient. The primary problem with this design is that it requires two emergency workers to use both of their hands to transport their patient. This is problematic because emergency workers typically carry equipment and may need to perform tasks on the patients while being transported. Later, wheels were added to rigid cots to make gurneys which are easier for emergency workers to move patients from a particular location into an emergency vehicle. These added wheels allowed patients to easily be wheeled across flat surfaces to an emergency vehicle. The added wheels are also configured to collapse such that the cot could be properly fitted into an emergency vehicle and serve as a bed during transportation to a hospital. Additional wheels were eventually added to the loading end of cots in order to minimize friction and facilitate wheeling the cot into an emergency vehicle.

While these wheeled gurney embodiments provide significant advantages over the traditional cloth type cots, there are still significant problems. For example, if the patient must be transported over uneven surfaces such as stairs, curbs, or inclines, the conventional wheeled gurney will still require at least two emergency workers to properly transport the patient. In addition, on steep and irregular inclines, it is very difficult to support and stabilize the uphill side of the wheeled cot because it will be disposed very close to the ground. Further, certain uneven surfaces may cause the cot to bounce or shift resulting in additional pain and possibly injury to the patient. Therefore, for at least these reasons there is a need in the industry for an improved cot.

### SUMMARY

The present invention relates to an emergency vehicle cot that includes an incline support system and a movement system. The incline support system is a retractable system disposed on the bottom of the cot to support one end the cot on an inclined and/or irregular surface during transportation. For example, one embodiment of an incline support system includes two members that are configured to extend from the inclined end of the cot at a particular angle. The extended members support the cot a particular distance over the inclined surface thereby minimizing the need for an emergency worker to manually support the inclined end of the cot. The movement system is coupled to the incline support system and utilizes rotational movement to allow the supported inclined end of the cot to move over the inclined surface. For example, one embodiment of a movement system includes a rotatable track with a motor system and a brake system. The incline support system and the movement system are configured to be retractable or concealable within the cot to facilitate using the cot as a traditional emergency vehicle cot.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1A is a top elevational view of one embodiment of a cot in accordance with the present invention;

FIG. 1B is a profile operational view of the cot illustrated in FIG. 1A during use over a substantially flat surface;

FIG. 1C is a bottom view of the cot illustrated in FIG. 1A;

FIG. 2A is a top elevational view of the cot illustrated in FIG. 1A in an alternative configuration in which two of the handles are extended;

FIG. 2B is a profile operational view of the cot illustrated in FIG. 2A during use over a substantially flat surface;

FIG. 2C is a bottom view of the cot illustrated in FIG. 2A;

FIG. 3A is a top elevational view of the cot illustrated in FIG. 1A in an alternative configuration in which the tracks are extended for traveling over an inclined surface;

FIG. 3B is a profile operational view of the cot illustrated in FIG. 3A during use over an irregular stepped surface;

FIG. 3C is a bottom view of the cot illustrated in FIG. 3A;

FIG. 4A is a top elevational view of the cot illustrated in FIG. 1A in an alternative configuration in which the sections are configured to support a patient in a sitting position and two of the tracks are extended for traveling over an inclined surface;

FIG. 4B is a profile operational view of the cot illustrated in FIG. 4A during use over an irregular stepped surface in which the patient is positioned upright;

FIG. 4C is a bottom view of the cot illustrated in FIG. 4A;

FIG. 5A is front view of one embodiment of one of the tracks for use on the cot in accordance with the present invention;

FIG. 5B is a profile view of the track illustrated in FIG. 5A; and

FIG. 6 is a profile operational view illustrating the placement of a cot in accordance with the present invention on top of a gurney.

### DETAILED DESCRIPTION OF THE PREFERRED EMBODIMENTS

Reference will now be made to the drawings to describe presently preferred embodiments of the invention. It is to be understood that the drawings are diagrammatic and schematic representations of the presently preferred embodiments, and are not limiting of the present invention, nor are they necessarily drawn to scale.

The present invention relates to an emergency vehicle cot that includes an incline support system and a movement system. The incline support system is a retractable system disposed on the bottom of the cot to support one end the cot on an inclined and/or irregular surface during transportation. For example, one embodiment of an incline support system includes two members that are configured to extend from the inclined end of the cot at a particular angle. The extended members support the cot a particular distance over the inclined surface thereby minimizing the need for an emergency worker to manually support the inclined end of the cot. The movement system is coupled to the incline support system and utilizes rotational movement to allow the supported inclined end of the cot to move over the inclined surface. For example, one embodiment of a movement system includes a rotatable track with a motor system and a brake system. The incline support system and the movement system are configured to be retractable or concealable within the cot to facilitate using the cot as a traditional emergency vehicle cot. Also, while embodiment of the present invention are directed to emergency vehicle cots, it will be appreciated that the teachings of the present invention are applicable to other fields.

The following terms are defined as follows:

“cot”—a device for transporting an individual from one location to an emergency vehicle. A cot can be placed on top of a gurney for wheeled transportation on flat surfaces.

“gurney”—a wheelable bed device used in hospitals and other facilities to easily transport patients over flat surfaces.

“inclined surface”—any surface with a substantial change in elevation, including but not limited to stairs, ramps, curbs, hills, etc.

“emergency vehicle”—any vehicle used to transport incapacitated individuals from one location to another including but not limited to ambulances, fire truck/engine, elderly car vehicles, helicopter, etc.

“patient”—any person or animal being carried by a cot, including but not limited to individuals and animals that are sick, elderly, injured, deceased, etc.

“emergency worker”—any individual who is responsible for moving an incapacitated individual from one location to an emergency vehicle, including but not limited to EMTs, firemen, ambulance drivers, doctors, paramedics, nurses, search and rescue, ski patrol, etc.

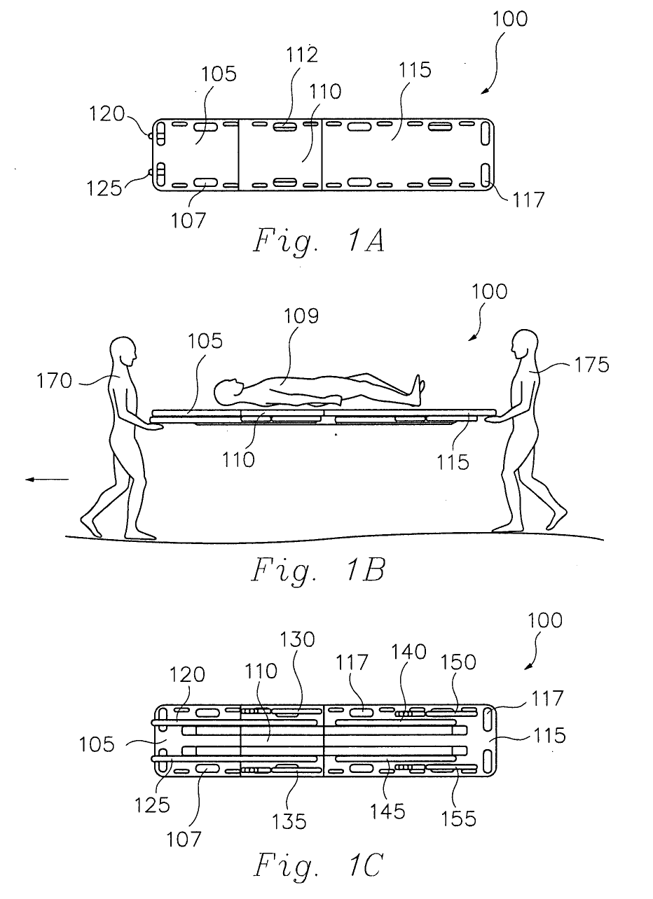

Reference is initially made to FIGS. 1A-1C, which illustrate different views of one embodiment of a cot in accordance with the present invention. FIG. 1A illustrates a top elevational view of the cot, which is designated generally at 100. The cot 100 further includes a platform with a top, middle, and bottom section 105, 110, 115. Although illustrated in a flat configuration, these sections 105, 110, 115 are configured to articulate with respect to one another in order to provide various transportation positions for a patient. Each section 105, 110, 115 also includes various recesses or hand grips 107, 112, 117. These hand grips 107, 112, 117 are positioned around the outer edges of the sections 105, 110, 115 to allow emergency workers to carry the cot from one location to another.

FIG. 1B illustrates a profile operational view of the cot 100 illustrated in FIG. 1A during use over a substantially flat surface. The illustrated profile view shows the cot 100 being used to transport a patient 109 by two emergency workers 170, 175, over a substantially flat surface. The emergency workers 170, 175 are located on the elongated ends of the cot 100 to efficiently transport the patient 109. In certain circumstances, it may be necessary for one or both emergency workers 170, 175 to carry the cot 100 from different lateral locations.

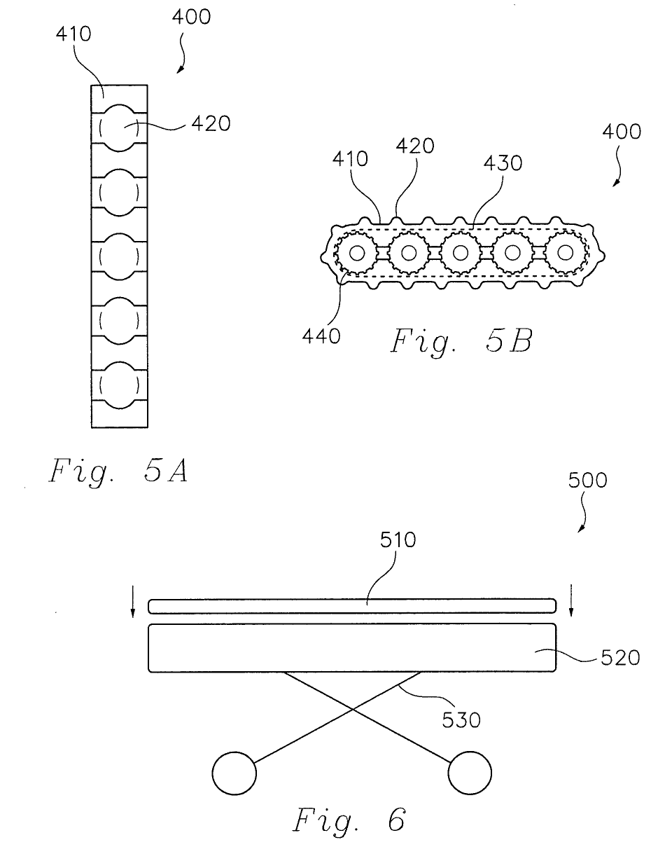

FIG. 1C illustrates a bottom view of the cot 100 illustrated in FIG. 1A. As seen in this figure, the cot 100 further includes a plurality of tracks 120, 125, 140, 145. The tracks include an incline support system and a movement system. The illustrated embodiment shows two top tracks 120, 125 and two bottom tracks 140, 145. The top tracks 120, 125 are disposed below the top and middle sections 105, 110 of the cot. Likewise, the bottom tracks 140, 145 are disposed below the bottom section 115 of the cot. Various track configurations may be used and remain consistent with the present invention. The tracks 120, 125, 140, 145 are extendable members configured to both support the cot 100 and facilitate translation over inclined surfaces utilizing rotational movement. The tracks 120, 125, 140, 145 are capable of extending away from the cot 100 at various angles and locking at least one predetermined angle with respect to the cot 100. The tracks 120, 125, 140, 145 are also configured to collapse and be positioned substantially parallel to the platform such that the cot can be configured to interface on top of a gurney. One specific embodiment of the tracks 120, 125, 140, 145 will be discussed in more detail with reference to FIGS. 5A and 5B.

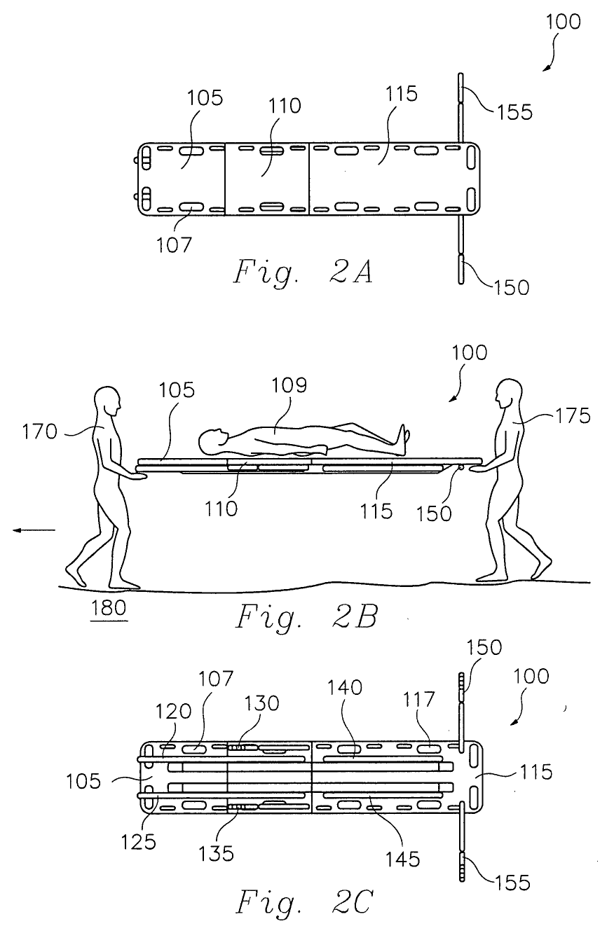

The illustrated embodiment of a cot 100 further includes a plurality of handles 130, 135, 150, 155. The handles 130, 135, 150, 155 include two top handles 130, 135 and two bottom handles 150, 155. The handles 130, 135, 150, 155 can be used by emergency workers to carry the cot from one location to another. The handles 130, 135, 150, 155 are configured to extend away from the cot 100 in a parallel orientation and lock at at least one predetermined angle. As shown, the handles 130, 135, 150, 155 are also configured to collapse and be positioned under the platform such that they do not protrude from the cot 100 in any way. FIGS. 2A-2C illustrate a different configuration of the cot 100 in which the handles 130, 135, 150, 155 are extended.

Reference is next made to FIGS. 2A-2C which illustrate various views of the cot 100 illustrated in FIG. 1A in a different configuration. FIG. 2A shows a top elevational view of the cot 100 with the bottom handles 150, 155 extended. FIG. 2B is a profile operational view of the cot illustrated in FIG. 2A during use over a substantially flat surface. In this situation, the emergency worker 175 can either hold the bottom handles 150, 155 or one of the hand grips 117 located on the bottom section of the platform. FIG. 2C is a bottom view of the cot illustrated in FIG. 2A. This view clearly illustrates the ability for the bottom handles 150, 155 to extend away from the cot 100 at a 90 degree angle but substantially parallel to the remainder of the cot 100.

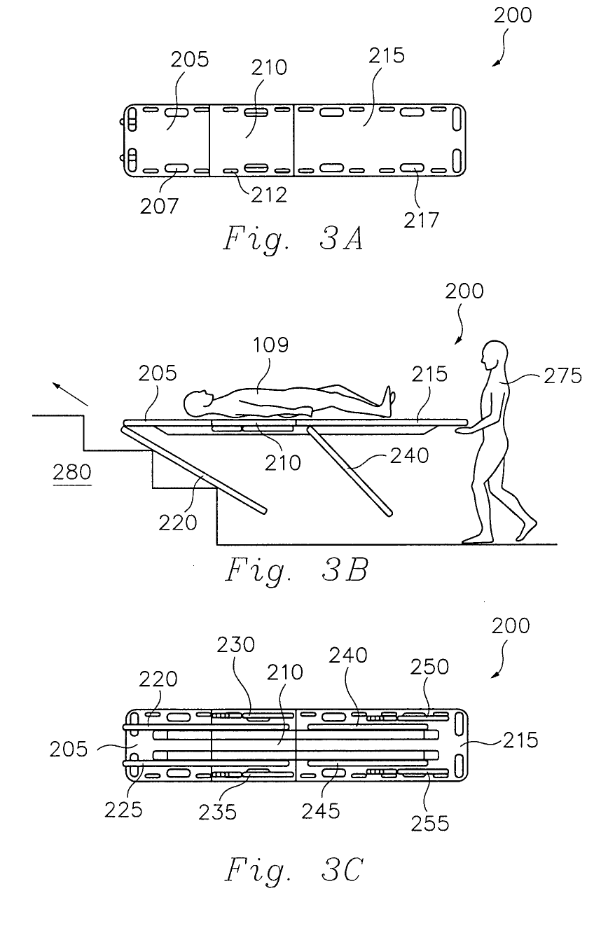

Reference is next made to FIGS. 3A-3C which illustrate various views of the cot illustrated in FIG. 1A in an alternative configuration. In this alternative configuration, the cot is designated generally at 200. FIG. 3A is a top elevational view of the cot 200. The cot 200 includes a top, middle, and bottom section 205, 210, 215 and each section has a plurality of hand grips 207, 209, 217. FIG. 3B is a profile operational view of the cot 200 illustrated in FIG. 3A during use over an irregular stepped surface 280. In order to transport a patient 209 to an emergency vehicle, it is often necessary to overcome an inclined surface. The tracks 220, 225, 240, 245 are extended and locked at a particular angle with respect to the remainder of the cot 200 in order to facilitate easily transporting the patient 209 over the inclined stepped surface 280. Only one emergency worker 275 is necessary for this operation since the tracks 220, 225, 240, 245 support the remainder of the cot 200. The tracks 220, 225, 240, 245 include a movement system that is configured to provide rotational movement such that the cot 200 is supported but can be translated using the rotational movement of the tracks 220, 225, 240, 245. Various movement systems may be incorporated with the tracks 220, 225, 240, 245 and remain consistent with the present invention. One system is described in more detail with reference to FIGS. 5A-5B.

In addition to allowing for rotational movement, the movement system may include equipping tracks 220, 225, 240, 245 with a motorized system (not shown). In addition, a control mechanism (not shown) is disposed on the cot 200 such that the emergency worker 275 can operate a brake system and the motorized system during transportation of the patient 209. Various brake systems and motorized systems may be used with the cot 200 and remain consistent with the present invention. The brake system may be a standard mechanical disc brake system with some form of lever disposed on the control mechanism. When an emergency worker 275 engages the lever, a cable is retracted causing a caliper to engage two brake pads on either side of a disc. The disc is staticly coupled to the rotational movement of the tracks 220, 225, 240, 245 thereby resulting in braking the rotational movement of the tracks 220, 225, 240, 245. Likewise, the motorized system may be an electrical motor coupled to the tracks 220, 225; 240, 245 that utilizes rechargeable and replaceable batteries. The electric motor may be a step type motor that automatically locks when power is lost. Alternatively, an extra mechanism may be included in the movement system to lock the rotational movement in the event that the power is lost to the standard electric motor. A coinciding battery charger could be located in the emergency vehicle and allow an emergency worker to recharge the battery at the end of the day or in-between patients. A rotational controller for the electric motor could be configured to cause the tracks 220, 225, 240, 245 to rotate forward when the rotational controller is rotated forward, and cause the tracks 220, 225, 240, 245 to rotate backward when the rotational controller is rotated backward. The use of a rotational controller to operate the motorized system and a brake lever to operate the brake system allows an emergency worker to maintain their supportive grip on the cot 200 while controlling the motorized system and brake system. The control mechanism could be located on the handles 150, 155 that were illustrated in an extended position in FIGS. 2A-2C. An additional item on the control mechanism may allow the emergency worker 275 to completely disengage the motorized system when transporting a patient down an inclined surface.

FIG. 3C is a bottom view of the cot illustrated in FIG. 3A. The cot 200 includes tracks 220, 225, 240, 245 and hand grips 230, 235, 250, 255. Since the tracks 220, 225, 240, 245 are rotated away from the remainder of the cot 200, they appear shorter than in FIGS. 1C and 2C.

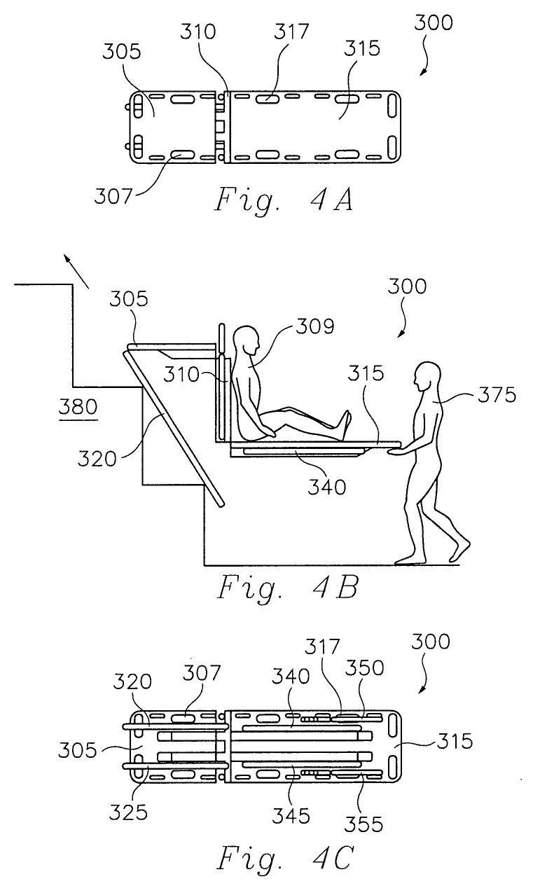

Reference is next made to FIGS. 4A-4C which illustrate various views of the cot illustrated in FIG. 1A in an alternative configuration in which the sections are configured to support a patient in a sitting position and two of the tracks are extended for traveling over an inclined surface. In this alternative configuration the cot is designated generally at 300. FIG. 4A illustrates a top elevational view of the cot 300 in this configuration. Sections 305, 310, 315 of the platform are configured to provide a stepped platform to allow a patient to be transported in an upright position. FIG. 4B is a profile operational view of the cot illustrated in FIG. 4A during use over an irregular stepped surface in which the patient is positioned upright. Only one emergency worker 375 is needed to support the cot 300 over an inclined surface in this configuration because the tracks 320, 325 support the other side of the cot 300. The patient 309 is positioned upright during transportation over the inclined surface 380. The tracks 320, 325, 340, 345 include a movement system that allows them to rotate. The emergency worker 375 may also engage a motor system and a brake system (not shown) as part of the movement system in order to safely ascend or descend the inclined surface 380 with the patient 309. The motor system and brake system are discussed in more detail with reference to FIGS. 3A-3C.

FIG. 4C is a bottom view of the cot illustrated in FIG. 4A. The cot 300 includes tracks 320, 325, 340, 345 and hand grips 330, 335, 350, 355. The orientation of sections 305, 310, 315 of the cot 300 appear different from FIGS. 1C, 2C, and 3C because the sections are rotated with respect to one another to create the stepped platform that is necessary to transport a patient 309 in an upright position. Likewise, the tracks 320, 325 appear shorter than in FIGS. 1C and 2C because they are extended away from the remainder of the cot 300.

Reference is next made to FIGS. 5A and 5B which illustrate various views of one of the tracks for use on the cot in accordance with the present invention. FIG. 5A is a front view of a track 400 illustrating the rubber outer surface 410 having flat regions and stepped regions 420. FIG. 5B is a profile view of the track 400 illustrating a plurality of geared rotational members 440, a segmented track wheel 410, and a rubber outer surface 410 having stepped regions 420. The geared rotational members 440 are coupled to the electric motor via some form of gearing system such that when the motor rotates, an appropriate rotational force is applied to the geared rotational members. The geared rotational members 440 then transfer the rotational force to the segmented track wheel 430 which is coupled to the rubber outer surface 410. The stepped regions 420 on the outer rubber surface are configured to grip irregular surfaces such as stairs during rotation. FIGS. 5A and 5B are merely one embodiment of a movement system for use with the tracks of the present invention.

FIG. 6 is a profile operational view illustrating the placement of a cot in accordance with the present invention on top of a gurney. A cot is designed for transportation of a patient from one location to an emergency vehicle. Once inside an emergency vehicle the cot may be placed on top of a gurney in the manner shown. Alternatively, a patient could be moved from a cot onto a gurney or any other type of patient support device.

In operation, the embodiment of a cot illustrated in FIGS. 1A-4C is utilized to transport a patient from one location to an emergency vehicle. The process of utilizing the cot in this manner may vary depending on the circumstances. Initially, a patient is relocated onto the cot in a manner to avoid further injury or discomfort. If the cot is disposed on a substantially flat surface, the cot is elevated and supported by two emergency workers using the hand grips or the handles. The patient is then transported to the emergency vehicle by the emergency workers. If an inclined surface is encountered during transportation to the emergency vehicle, one end of the cot is supported on the inclined surface while the corresponding or second emergency worker engages an incline support system including a plurality of tracks. The remaining emergency worker then directs the cot utilizing the movement system over the inclined surface. Once the cot encounters a substantially flat surface, the second emergency worker again supports the cot and disengages the inclined support system including the tracks. Utilizing this process, the cot and patient are eventually positioned within the emergency vehicle.

The present invention may be embodied in other specific forms without departing from its spirit of essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed is:

1. A cot configured for use with an emergency vehicle, comprising:
at least one platform for supporting a patient during transportation;
an incline support system coupled to the at least one platform configured to support an inclined end of the at least one platform during transportation over an inclined surface; and wherein the incline support system collapses when positioned within the emergency vehicle;
a movement system coupled to the incline support system that is configured to allow the supported end of the cot to ascend and descend an inclined surface utilizing motorized and non-motorized rotational movement; and
a control mechanism coupled to the at least one platform and the movement system that allows an individual to control the operation of the movement system.

2. The cot of claim 1, wherein the at least one platform further includes a top section, a middle section, and a bottom section; and wherein the sections can pivot with respect to one another to allow positioning the patient in different configurations during transportation.

3. The cot of claim 1, wherein the cot is configured to interface on top of a gurney to facilitate wheeled translation over a substantially flat surface.

4. The cot of claim 1, wherein the incline support system includes two tracks that extend and lock at a particular angle with respect to the cot.

5. The cot of claim 1, wherein the incline support system includes a suspension system for minimizing impacts on a patient during transportation.

6. The cot of claim 1, wherein the movement system further includes a motor and at least one rotational device coupled to the motor.

7. The cot of claim 6, wherein the motor is electric and further includes a power source.

8. The cot of claim 7, wherein the power source is a replaceable rechargeable battery.

9. The cot of claim 6, wherein the at least one rotational device includes at least two tracks.

10. The cot of claim 9, wherein the at least two tracks include protruding rubber ribs to allow for gripping stairs and other irregular inclined surfaces.

11. The cot of claim 1, wherein the control mechanism includes a braking system that slows and stops the rotational movement of the movement system when engaged.

12. The cot of claim 11, wherein the braking system is substantially mechanical.

13. The cot of claim 1, wherein the control mechanism includes a forward and reverse mechanism that allows the movement system to move forward and reverse respectively.

14. The cot of claim 1, wherein the movement system is designed to lock in the event that power is lost.

15. The cot of claim 1, wherein a motorized portion of the movement system can be disengaged thereby allowing for descent of an inclined surface utilizing non-motorized rotational movement.

16. A cot configured for use with an emergency vehicle, comprising:
At least one platform for supporting a patient during transportation;
an incline support system coupled to the at least one platform configured to support an inclined end of the at least one platform during transportation over an inclined surface; and wherein the incline support system collapses when positioned within the emergency vehicle;
a movement system coupled to the incline support system that is configured to allow the supported end of the cot to ascend and descend an inclined surface utilizing motorized and non-motorized rotational movement, and wherein the movement system includes an electric motor and a replaceable power source; and
a control mechanism coupled to the at least one platform and the movement system that allows an individual to control the operation of the movement system, and wherein the control mechanism includes a mechanical brake that is configured to slow and stop the rotational movement of the movement system when engaged.

17. A method of transporting a patient over an inclined surface to an emergency vehicle comprising the acts of:
disposing the patient on a cot;
transporting the patient to an inclined surface en route to the emergency vehicle;
engaging an inclined support system on an inclined end of the cot;
engaging a movement system on the cot causing the inclined end of the cot to utilize rotational movement to translate over the inclined surface;
directing the rotational movement of the cot over the inclined surface, to the emergency vehicle;
disengaging and collapsing the inclined support system and the movement system substantially flush with the remainder of the cot; and
disposing the cot within the emergency vehicle.

18. The method of claim 17, wherein the act of disposing the patient on a cot further includes the acts of:
moving the cot from the emergency vehicle to the patient; and
moving the patient onto the cot.

19. The method of claim 17, wherein the act of transporting the patient to an inclined surface en route to the emergency vehicle further includes the acts of:
manually raising both ends of the cot; and
lowering and releasing the inclined end of the cot on the inclined surface.

20. The method of claim 17, wherein the act of engaging an inclined support system on the inclined end of the cot further includes the acts of:
positioning the cot such that the end on which the support system is located, is the incline end of the cot; and
extending the inclined support system from an underside of the cot.

21. The method of claim 17, wherein the act of engaging a movement system on the cot further includes the act of operating a control system which causes a motor to generate rotational movement on the inclined end of the cot.

22. The method of claim 17, wherein the act of directing the rotational movement of the cot over the inclined surface, to the emergency vehicle further includes the acts of:
operating a control system to direct the cot in the direction of the emergency vehicle;
operating a control system to overcome and avoid obstacles during translation of the cot to the emergency vehicle.

23. The method of claim 17, wherein the act of disengaging and collapsing the inclined support system and the movement system substantially flush with the remainder of the cot further includes folding the inclined support system and the movement system under the cot such that the bottom of the cot is substantially flat and can be placed on a flat surface without causing instability.
